(19) United States
(12) Patent Application Publication
(10) Pub. No.: US 2026/0222773 A1
(43) Pub. Date: Jul. 30, 2026

(54) Local Sensing Integration for Integrated Sensing and Communication

(71) Applicant: Apple Inc., Cupertino, CA (US)

(72) Inventors: Xiaoyu QIAO, Beijing (CN); Dawei ZHANG, Saratoga, CA (US); Fangli XU, Beijing (CN); Haijing HU, Los Gatos, CA (US); Huarui LIANG, Beijing (CN); Lanpeng CHEN, Beijing (CN); Mona AGNEL, Guildford (GB); Shu GUO, Beijing (CN); Yingluo LUO, Beijing (CN)

(21) Appl. No.: 19/145,358

(22) PCT Filed: Jan. 11, 2023
(86) PCT No.: PCT/CN2023/071790

§ 371 Date: Jul. 2, 2025

(51) Int. Cl. H04W 4/38

(52) U.S. Cl. CPC H04W 4/38

(57) ABSTRACT

A sensing function control plane (SF-C) is configured to receive a sensing session establishment request from an access and mobility management function (AMF) of a core network, wherein the SF-C is located in the core network, select a sensing function user plane (SF-U) for a sensing session in response to the request, wherein the SF-U is located outside of the core network and receive sensing data processing results from the SF-U.

### TECHNICAL FIELD

This application relates generally to wireless communication systems, and in particular relates to local sensing integration for integrated sensing and communication.

### BACKGROUND

Wireless sensing may be used to acquire information about a remote object and its characteristics without physically contacting the object. The sensing information may be derived from radio frequency (RF) based and/or non-RF based sensors. A wireless communication system may be configured with integrated sensing and communication where sensing services are provided by the same system and infrastructure that is used for communication.

### SUMMARY

Some exemplary embodiments are related to a method performed by a sensing function control plane (SF-C). The method includes receiving a sensing session establishment request from an access and mobility management function (AMF) of a core network, wherein the SF-C is located in the core network, selecting a sensing function user plane (SF-U) for a sensing session in response to the request, wherein the SF-U is located outside of the core network and receiving sensing data processing results from the SF-U.

Other exemplary embodiments are related to a method performed by a sensing function user plane (SF-U). The method includes receiving a sensing session establishment request from a sensing function control plane (SF-C), wherein the SF-C is located in a core network and the SF-U is located outside of the core network, processing sensing data for a sensing session and transmitting sensing data processing results to the SF-C or a radio access network (RAN) node.

### BRIEF DESCRIPTION OF THE DRAWINGS

FIG. 1 shows an exemplary arrangement according to various exemplary embodiments.

FIG. 2 shows an exemplary network architecture according to various exemplary embodiments.

FIG. 3 shows a signaling diagram for sensing session establishment according to various exemplary embodiments.

FIG. 4 shows an exemplary user equipment (UE) according to various exemplary embodiments.

FIG. 5 shows an exemplary base station according to various exemplary embodiments.

### DETAILED DESCRIPTION

The exemplary embodiments may be further understood with reference to the following description and the related appended drawings, wherein like elements are provided with the same reference numerals. The exemplary embodiments relate to integrated sensing and communication.

The exemplary embodiments are described with regard to a fifth generation (5G) new radio (NR) network. However, reference to a 5G NR network is merely provided for illustrative purposes. The exemplary embodiments may be applied to any type of wireless communication system with integrated sensing and communication.

Wireless sensing may be used to acquire information about a remote object and its characteristics without physically contacting the object. The perception data of the object and its surroundings may be utilized for analysis so that meaningful information about the object and its characteristics may be obtained. Radar is one example of a wireless sensing technology and uses radio waves to determine certain characteristics about remote objects (e.g., distance, angle, velocity, etc.). Other types of wireless sensing technologies include, but are not limited to, time of flight cameras, accelerometers, gyroscopes and Lidar. Throughout this description, any reference to a particular type of wireless sensing technology is merely provided for illustrative purposes. The exemplary embodiments may be utilized with any appropriate type of radio frequency (RF)-based and/or non-RF based sensors.

The exemplary embodiments are further described with regard to integrated sensing and communication in a 5G system. Those skilled in the art will understand that integrated sensing and communication refers to a concept where sensing services are provided by the same 5G new radio (NR) wireless communication system and infrastructure that is used for communication. This concept may encompass communication assisted sensing where the communication system provides sensing services or sensing assisted communication where sensing information of the communication channel or environment is used to improve the communication performance of the system. Sensing services may be used for various different types of use cases. To provide some examples, use cases such as, but not limited to, intelligent transportation, aviation, whether monitoring, health monitoring, smart factories and intruder detection in a smart home may benefit from a 5G system with integrated sensing and communication.

The exemplary embodiments introduce an approach to integrated sensing and communication that uses local sensing data processing. Throughout this description, this approach may be generally referred to as “local sensing integration.” Local sensing integration generally refers to a concept where the sensing data is processed locally instead of being transmitted to the core network for processing. For example, sensing data processing may occur at UEs, base stations, RAN nodes and/or edge network nodes. In one aspect, local sensing integration minimizes the network signaling overhead associated with sensing data transmission and processing. In another aspect, local sensing integration introduces less of a delay than a central processing approach.

Local sensing integration may use a split control plane and user plane. For the control plane, a sensing function-control plane (SF-C) is introduced to process control plane signals for sensing services. In some embodiments, the SF-C may be implemented in the core network for easy interaction with other network functions. For the user plane, a sensing function-user plane (SF-U) is introduced to receive and process sensing data. The SF-U may be implemented locally at different components to enable shorter sensing data transmission distance and local sensing data processing in applicable scenarios. For example, sensing data processing may occur at UEs, base stations, RAN nodes and/or edge network nodes. However, reference to the terms SF-C and SF-U are merely provided for illustrative purposes. Different entities may refer to similar concepts by a different name.

As mentioned above, the exemplary embodiments introduce enhancements to network architecture (e.g., SF-C, SF-U) for local sensing integration. In addition, the exemplary embodiments also introduce mechanisms related to sensing data transmission and processing in a network with local sensing integration. The exemplary embodiments may be used independently from one another, in conjunction with other currently implemented integrated sensing and communication mechanisms, future implementations of integrated sensing and communication mechanisms or independently from other integrated sensing and communication mechanisms.

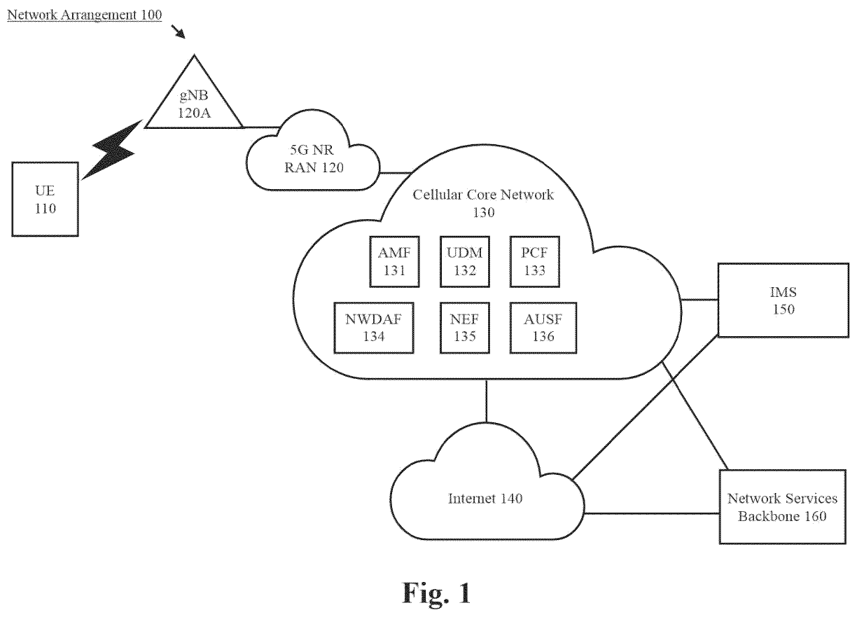

The exemplary network arrangement 100 is provided as a general overview of an exemplary wireless communication system. The exemplary SF-C and SF-U introduced herein are not shown in the network arrangement 100. These components are described in detail below with regard to network architecture 200. However, it should be understood that the exemplary SF-C and SF-U may reside in various locations shown in the network arrangement 100. These locations may include, within the radio access network (e.g., RAN 120), within the core network 130, as separate components outside of the locations described with respect to FIG. 1, etc.

FIG. 1 shows an exemplary network arrangement 100 according to various exemplary embodiments. The exemplary network arrangement 100 includes a user equipment (UE) 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

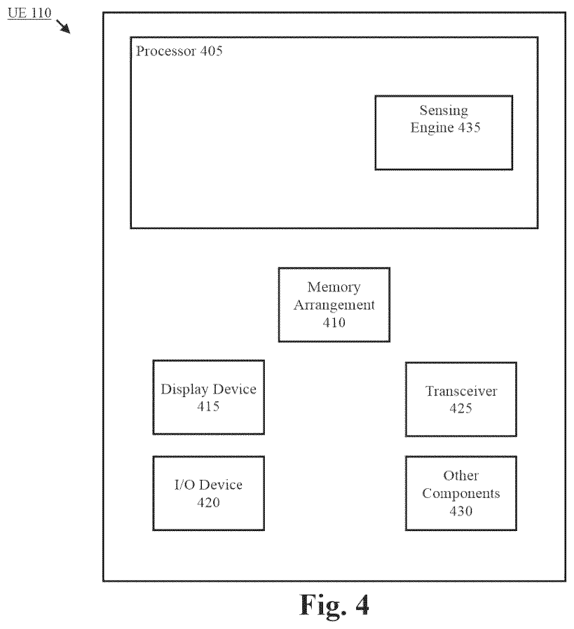

In some of the examples provided below, the UE 110 may be characterized as a sensor. Throughout this description, a sensor may be used to generally refer to a device that collects sensing data. In some embodiments, the UE 110 may be equipped with the hardware, software and/or firmware needed to generate sensing data. In other embodiments, the UE 110 may be connected to another electronic component that generates the sensing data. A detailed description of the UE 110 is provided below with reference to FIG. 4.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include, for example, nodes or base stations (e.g., Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the next generation Node B (gNB) 120A.

In some of the examples provided below, the gNB 120A, a node operated by the gNB 120A and/or any other type of RAN node may be characterized as a sensor. As mentioned above, throughout this description, the term sensor may be used to generally refer to a device that collects sensing data. In some embodiments, a network node may be equipped with the hardware, software and/or firmware to generate the sensing data. In other embodiments, the network node may be connected to another electronic component that generates the sensing data. Thus, throughout this description, a sensor may refer to a UE or network node that collects sensing data.

The network arrangement 100 also includes a cellular core network 130. The cellular core network 130 may refer to an interconnected set of components that manages the operation and traffic of the cellular network. It may include network functions such as, but not limited to, an access management and mobility function (AMF) 131, a unified data management function (UDM) 132, a policy control function (PCF) 133, a network data analytics function (NWDAF) 134, a network exposure function (NEF) 135 and an authentication server function (AUSF) 136.

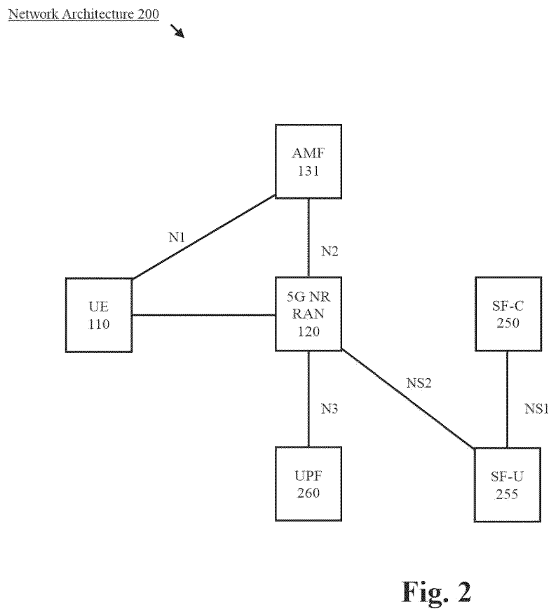

The exemplary SF-C and SF-U introduced herein may reside in various physical and/or virtual locations. Although not shown in FIG. 1, it should be understood that the SF-C and SF-U may be located at certain locations shown in FIG. 1. For example, in some embodiments, the SF-C may be located in the core network 130 for easier communication with the core network 130 functions. To provide another example within the context of FIG. 1, the SF-U may reside at the UE 110 and/or the gNB 120A. However, these examples are not intended to limit the exemplary embodiments in any way. The exemplary SF-C and SF-U are described in detail below with regard to network architecture 200 of FIG. 2.

The AMF 131 is generally responsible for connection and mobility management in the 5G NR RAN 120. Those skilled in the art will understand that the AMF 131 is a control plane function and may perform operations related to registration management and connection management. For example, the AMF 131 may perform operations related to registration management between the UE 110 and the core network 130. The exemplary embodiments are not limited to an AMF that performs the above referenced operations. Those skilled in the art will understand the variety of different types of operations an AMF may perform. Further, reference to a single AMF is merely for illustrative purposes, an actual network arrangement may include any appropriate number of AMFs.

The UDM 132 may perform operations related to handling subscription-related information to support the network's handling of communication sessions. The UDM 132 may be equipped with one or more communication interfaces to communicate with other network components (e.g., network functions, RANS, UEs, etc.). The exemplary embodiments are not limited to an UDM that performs the above reference operations. Those skilled in the art will understand the variety of different types of operations a UDM may perform. Further, reference to a single UDM is merely for illustrative purposes, an actual network arrangement may include any appropriate number of UDMs.

The PCF 133 may perform operations related to the control plane such as, but not limited to, managing policy rules for control plane functions including network slicing, roaming and mobility management. The PCF 133 may be equipped with one or more communication interfaces to communicate directly or indirectly with other network components (e.g., network functions, RANs, UEs, etc.). The exemplary embodiments are not limited to a PCF that performs the above referenced operations. Those skilled in the art will understand the variety of different types of operations a PCF may perform. Further, reference to a single PCF is merely for illustrative purposes, an actual network arrangement may include any appropriate number of PCFs.

The NWDAF 134 is a network function that performs operations for network automation such as receiving input from other network components (e.g., network functions, UEs, cells, etc.), performing an analysis on the input and generating an output based on the analysis. However, reference to an NWDAF is merely provided for illustrative purposes, different entities may refer to a similar concept by a different name. Accordingly, the NWDAF as described herein may represent any mechanism used to perform analytics for network automation. Further, reference to a single NWDAF is merely for illustrative purposes, an actual network arrangement may include any appropriate number of NWDAFs.

The NEF 135 is generally responsible for securely exposing the services and capabilities provided by 5G NR RAN network functions. The NEF 135 may be equipped with one or more communication interfaces to communicate with other network components (e.g., network functions, RANs, UEs, etc.). The exemplary embodiments are not limited to a NEF that performs the above reference operations. Those skilled in the art will understand the variety of different types of operations a NEF may perform. Further, reference to a single NEF is merely for illustrative purposes, an actual network arrangement may include any appropriate number of NEFs.

The AUSF 136 may store data for authentication of UEs and handle authentication-related functionality. The AUSF 136 may be equipped with one or more communication interfaces to communicate with other network components (e.g., network functions, RANS, UEs, etc.). The exemplary embodiments are not limited to a AUSF that performs the above referenced operations. Those skilled in the art will understand the variety of different types of operations a AUSF may perform. Further, reference to a single AUSF is merely for illustrative purposes, an actual network arrangement may include any appropriate number of AUSFs.

The network arrangement 100 further includes the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

FIG. 2 shows an exemplary network architecture 200 according to various exemplary embodiments. The exemplary architecture 200 is provided as one example of a non-roaming architecture configured for local sensing integration.

In various examples provided below, reference is made to the components shown in the network arrangement 100. Those skilled in the art will understand that the components of the exemplary architecture 200 may reside in various physical and/or virtual locations relative to the network arrangement 100 of FIG. 1. These locations may include, within the access network (e.g., RAN 120), within the core network 130, as separate components outside of the locations described with respect to FIG. 1, etc. However, reference to FIG. 1 is merely for illustrative purposes. The exemplary network architecture 200 is not limited to the network arrangement 100 shown in FIG. 1 and may be used with any appropriate type of wireless communication system.

Some components are shown as being connected via connections labeled Nx (e.g., N1, N3). Those skilled in the art will understand that each of these connections (or interfaces) are defined in the 3GPP Specifications. The exemplary architecture 200 is using these connections in the manner in which they are defined in the 3GPP Specifications and may be modified in accordance with the exemplary embodiments described herein. Furthermore, while these interfaces are termed connections throughout this description, it should be understood that these interfaces are not required to be direct wired or wireless connections, e.g., the interfaces may communicate via intervening hardware and/or software components. To provide an example, the UE 110 may exchange signals over the air with the gNB 120A. However, in the architecture 200 the UE 110 is shown as having a connection to the AMF 205. This connection or interface is not a direct communication link between the UE 110 and the AMF 205, instead, it is a connection that is facilitated by intervening hardware and software components. Thus, throughout this description the terms “connection” and “interface” may be used interchangeably to refer to the Nx interface between the various components.

In the network architecture 200, the UE 110 may connect to the AMF 131 via the N1 interface and the 5G NR RAN 120 may connect to the AMF 131 via the N2 interface. The AMF 131 may also connect to other network functions shown in the network arrangement 100, e.g., the AUSF 136, the UDM 132, etc.

In the network architecture 200, the 5G NR RAN 120 may connect to a user plane function (UPF) 260 via the N3 interface. The UPF 260 may perform operations related packet data unit (PDU) session management and other types of data flow management. For example, the UPF 260 may facilitate a connection between the UE 110 and a data network (e.g., Internet 140). The UPF 260 may be equipped with one or more communication interfaces (e.g., N3, etc.) to communicate directly or indirectly with other network components (e.g., network functions, RANs, UEs, etc.). The exemplary embodiments are not limited to an UPF that performs the above referenced operations. Those skilled in the art will understand the variety of different types of operations an UPF may perform. Further, reference to a single UPF is merely for illustrative purposes, an actual network arrangement may include any appropriate number of UPFs.

As mentioned above, for local sensing integration, the user plane and the control plane may be split. The SF-C 250 is introduced to process control plane signals for sensing integration. In some examples, the SF-C 250 may be deployed in the core network 130 to facilitate efficient interactions with other core network functions. Further, reference to a single SF-C is merely for illustrative purposes, an actual network arrangement may include any appropriate number of SF-Cs.

In some embodiments, the SF-C 250 may be configured to perform various operations related to sensing access and mobility management for different types of sensors (e.g., UEs, RAN nodes, etc.). Sensing access and mobility management operations may encompass, but are not limited to, sensor registration management, sensor corrections management, sensor mobility management, sensor access and authentication, sensor access and authorization, initiating access node specific sensing management information and provisioning external parameters for sensing. In some embodiments, the SF-C 250 may be configured to perform various operations related to sensing session management. Sensing session management may encompass, but is not limited to, sensing session establishment, sensing session modification, sensing session release, selection and control of SF-U, termination of interfaces towards PCFs for sensing and provisioning external parameters for sensing.

The SF-U 255 is introduced to receive and process sensing data. In some examples, the SF-U 255 may be deployed locally (e.g., base station, RAN node, edge network, etc.) for shorter sensing data transmission distance and local sensing data processing. Further, reference to a single SF-U is merely for illustrative purposes, an actual network arrangement may include any appropriate number of SF-Us.

In some embodiments, the SF-U 255 may be configured to perform various operations such as, but not limited to, retrieving sensing data from the RAN and/or UEs via the RAN, sensing data processing, transmitting sensing data processing output to the core network and/or RAN, sensing traffic usage and reporting, serving as an anchor point for intra/inter-RAT mobility sensing and user plane sensing policy rule enforcement.

The SF-C 250 and/or SF-U 255 may be configured with one or more interfaces to enable communication with other network components shown in the network arrangement 100 (e.g., UDM 132, PCF 133, NWDAF 132, NEF 135, etc.). In addition, the SF-C 250 and/or SF-U 255 may be configured with one or more interfaces to enable communication with other network components not shown in the network arrangement 100 or network architecture 200 (e.g., a unified data storage function (UDSF), a network repository function (NRF), etc.).

In the network architecture 200, the SF-U 255 may connect to the 5G NR RAN 120 via the NS2 interface and the SF-C 250 via the NS1 interface. The SF-C 250 connects to the AMF 131 via the NSamf interface. In this description, reference to an “NSx” interface (e.g., NS1, NS2, NSamf) is merely provided for illustrative purposes, the NSx classification provided herein may serve as a placeholder. In an actual deployment scenario, this new interface may be assigned any appropriate number or label. Further, while these interfaces are termed connections throughout this description, it should be understood that these interfaces are not required to be direct wired or wireless connections, e.g., the interfaces may communicate via intervening hardware and/or software components.

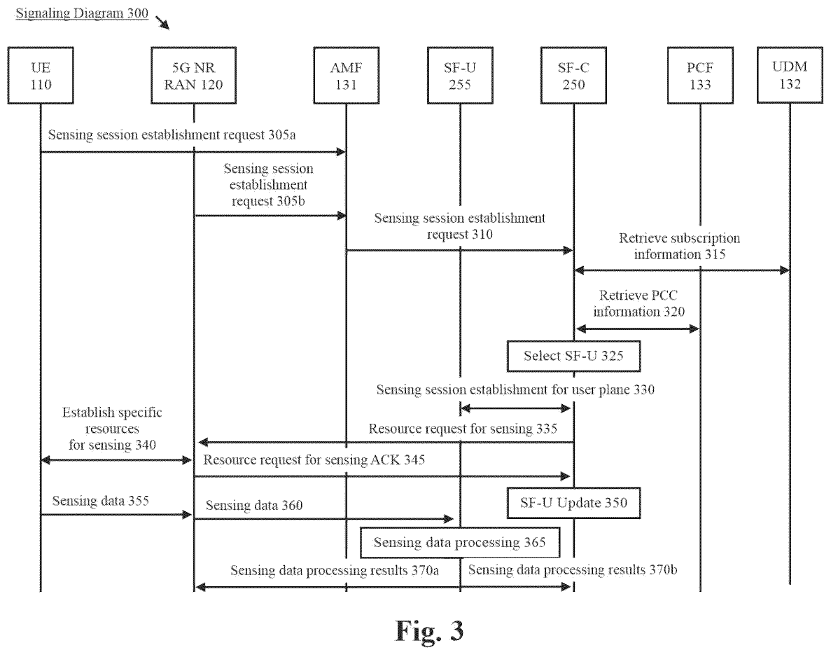

FIG. 3 shows a signaling diagram 300 for sensing session establishment according to various exemplary embodiments. The signaling diagram 300 is described with regard to the network architecture 200 of FIG. 2 and the network arrangement 100 of FIG. 1. The signaling diagram 300 includes the UE 110, the 5G NR RAN 120, the AMF 131, the SF-U 255, the SF-C 150, the PCF 133 and the UDM 132.

A sensing session may be initiated by a sensor, e.g., the UE 110 or a node of the 5G NR RAN 120. This is shown in the signaling diagram 300 by the messages 305a and 305b. To provide one example, certain applications like video games may use a gesture or movement of a user for game play. The UE 110 may collect data from internal components and/or another device connected to the UE 110 (e.g., smart watch, wearable, heads up display, etc.) indicative of gestures and/or movements of the user, e.g., sensing data. The UE 110 or the network may establish a sensing session to process the sensing data locally at an SF-U 255 instead of by a network function deployed in the core network.

In 305a, the UE 110 sends a sensing session establishment request to the AMF 131. According to some exemplary embodiments, the UE 110 may initiate a UE requested sensing session establishment procedure by transmitting a non-access stratum (NAS) message with a sensing session establishment request to the AMF 131 in an N1 container via the N1 interface. The UE 110 initiated sensing session establishment request may include a sensing session ID generated by the UE 110, requirements for the sensing session and/or any other appropriate type of parameter.

In 305b, a RAN node of the 5G NR RAN 120 sends a sensing session establishment request to the AMF 131. According to some exemplary embodiments, the RAN node may initiate a RAN node requested sensing session establishment procedure by transmitting a NAS message with a sensing session establishment request to the AMF 131 in an N2 container via the N2 interface. The RAN node initiated sensing session establishment request may include a sensing session ID generated by the RAN node of the 5G NR RAN 120, requirements for the sensing session and/or any other appropriate type of parameter.

Regardless of which entity initiated the sensing session establishment procedure, in 310, the AMF 131 transmits a sensing session request SF-C 250. The request provided by the AMF 131 may include the sensing session ID provided by the UE 110 in 305a or the RAN node in 305b, requirements for the sensing session and/or any other appropriate type of parameter.

In 315, the SF-C 250 may retrieve subscription information from the UDM 132. This may include the SF-C 250 transmitting a request to the UDM 132 and the UDM 132 transmitting a response to the SF-C 250. However, the above example is merely provided for illustrative purposes. The exemplary embodiments are not required to utilize this type of signaling exchange to retrieve the subscription information. The SF-C 250 may acquire the subscription information in any appropriate manner.

In 320, the SF-C 250 may retrieve policy and charging control (PCC) information from the PCF 133. This may include the SF-C 250 transmitting a request to the PCF 133 and the PCF 133 transmitting a response to the SF-C 250. However, the above example is merely provided for illustrative purposes. The exemplary embodiments are not required to utilize this type of signaling exchange to retrieve the subscription information. The SF-C 250 may acquire the PCC information in any appropriate manner.

In 325, the SF-C 250 selects an SF-U to provide user plane services for a sensing session. In this example, the SF-C 250 selects the SF-U 255. However, in an actual deployment scenario there may be multiple SF-Us to choose from. The SF-C 250 may select an SF-U to provide user plane services for a sensing session of a sensor (e.g., UE, RAN node, etc.) based on any appropriate condition.

In 330, the SF-C 250 and SF-U 255 establish a sensing session for the user plane. This may include the SF-C 250 transmitting a request to the SF-U 255 via the NS1 interface and the SF-U 255 transmitting a response to the SF-C 250 via the NS1 interface. However, the above example is merely provided for illustrative purposes. The exemplary embodiments are not required to utilize this type of signaling exchange for sensing session establishment for the user plane. The SF-C 250 and SF-U 255 may establish this relationship in any appropriate manner.

In 335, the SF-C 250 transmits an access node resource request for sensing to the RAN node of the 5G NR RAN 120.

In 340, the RAN node and the UE 110 establish access node specific resources for sensing. This may include the RAN node transmitting a request to the UE 110 and the UE 110 transmitting a response to the RAN node. However, the above example is merely provided for illustrative purposes. The exemplary embodiments are not required to utilize this type of signaling exchange to establish access node specific resources or sensing. The UE 110 may be made aware of the specific resources to be used for sensing in any appropriate manner.

As mentioned above, the UE 110 or the RAN node may initiate sensing session establishment. For RAN node initiated sensing session establishment, it may be unnecessary for the RAN node and the UE 110 establish access node specific resources for sensing as shown in 335.

In 345, the RAN node transmits an access node resource request for sensing acknowledgement (ACK) to the SF-C 250 in response to the request in 330.

In 350, the SF-C 250 may perform a SF-U update. For example, after the SF-U selection in 325, conditions may change and the SF-C 255 may select a different SF-U for sensing data processing. If a new SF-U is selected in 350, the SF-C 250 and the new SF-U may perform sensing session establishment for the user plane before the new SF-U is able to process the sensing data. However, an SF-U update is not required to be performed and, as shown in this example, the SF-U selected in 325 may continue to process data for the sensing session.

Regardless of which entity initiated the sensing session establishment procedure, the UE 110 and/or the RAN node of the 5G NR RAN 120 may collect sensing data and provide it to the SF-U 255 for processing. This is shown in 355 where the UE 110 sends sensing data to the 5G NR RAN 120 and 360 where the RAN node sends sensing data to the SF-U 255.

When a sensing session is established between the UE 110 and the SF-U 255, sensing data may be provided by the UE 110 to the SF-U 255 via the 5G NR RAN 120 over the NS2 interface. When a sensing session is established between a RAN node of the 5G NR RAN 120 and the SF-U 255, sensing data may be provided by the RAN node to the SF-U 255 via the S2 interface. Multiple sensing sessions may be established simultaneously for the same or different independent sensing objectives. Thus, there may be a scenario where the UE 110 and the RAN node are both providing sensing data to the SF-U 255 for a same or different sensing objective.

In 365, the SF-U 255 processes the sensing data. The output of the processing performed by the SF-U 255 may be provided to the 5G NR RAN 120 and/or the SF-C 255. This is shown in 370a where the SF-C 255 sends sensing data processing results to the 5G NR RAN 120 and 370b where the SF-U 255 also transmits sensing data processing results to the SF-C 250. Although not shown in the signaling diagram 300, the SF-C 250 may then provide the sensing data processing results to the other network functions.

FIG. 4 shows an exemplary UE 110 according to various exemplary embodiments. The UE 110 will be described with regard to the network arrangement 100 of FIG. 1 and the network architecture 200 of FIG. 2. The UE 110 may include a processor 405, a memory arrangement 410, a display device 415, an input/output (I/O) device 420, a transceiver 425 and other components 430. The other components 430 may include, for example, an audio input device, an audio output device, a power supply, a data acquisition device, ports to electrically connect the UE 110 to other electronic devices, cameras, accelerometers, gyroscopes, radar, lidar, any other appropriate type of RF-based sensor, any other appropriate type of non-RF based sensor, etc.

The processor 405 may be configured to execute a plurality of engines of the UE 110. For example, the engines may include a sensing engine 435. The sensing engine 435 may perform various operations related to integrated sensing and communication. The operations may include, but are not limited to, establishing a sensing session, communicating with the SF-C 250, communicating with the SF-U 255, collecting sensing data, processing sensing data locally at the UE 110 and transmitting sensing data to the network.

The above referenced engine 435 being an application (e.g., a program) executed by the processor 405 is merely provided for illustrative purposes. The functionality associated with the engine 435 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 405 is split among two or more processors such as a baseband processor and an applications processor. The exemplary embodiments may be implemented in any of these or other configurations of a UE.

The memory arrangement 410 may be a hardware component configured to store data related to operations performed by the UE 110. The display device 415 may be a hardware component configured to show data to a user while the I/O device 420 may be a hardware component that enables the user to enter inputs. The display device 415 and the I/O device 420 may be separate components or integrated together such as a touchscreen. The transceiver 425 may be a hardware component configured to establish a connection with the 5G NR-RAN 120, an LTE-RAN (not pictured), a legacy RAN (not pictured), a WLAN (not pictured), etc. Accordingly, the transceiver 425 may operate on a variety of different frequencies or channels (e.g., set of consecutive frequencies).

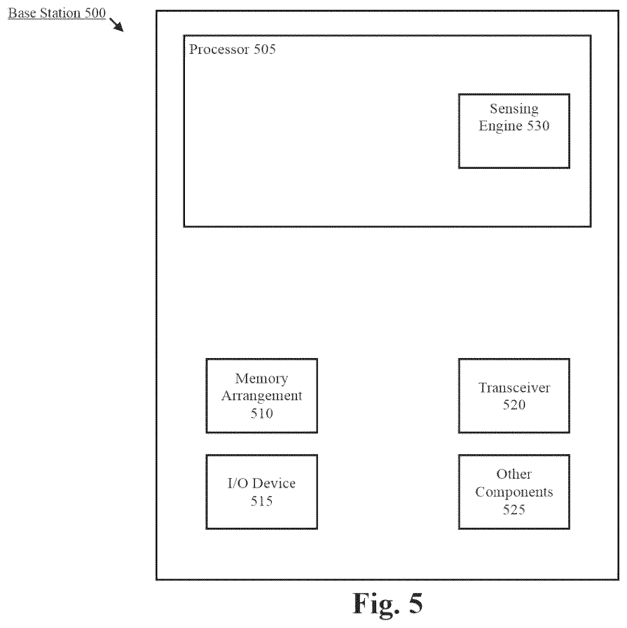

FIG. 5 shows an exemplary base station 500 according to various exemplary embodiments. The base station 500 may represent the gNB 120A or any other access node through which the UE 110 may establish a connection and manage network operations.

The base station 500 may include a processor 505, a memory arrangement 510, an input/output (I/O) device 515, a transceiver 520 and other components 525. The other components 525 may include, for example, an audio input device, an audio output device, a battery, a data acquisition device, ports to electrically connect the base station 500 to other electronic devices and/or power sources, cameras, radar, lidar, any other appropriate type of RF-based sensor, any other appropriate type of non-RF based sensor, etc.

The processor 505 may be configured to execute a plurality of engines for the base station 500. For example, the engines may include a sensing engine 530. The sensing engine 530 may perform various operations related to integrated sensing and communication. The operations may include, but are not limited to, establishing a sensing session, communicating with the SF-C 250, communicating with the SF-U 255, collecting sensing data, processing sensing data locally at the base station 500 and transmitting sensing data to the UE 110 and/or other network nodes.

The above noted engine 530 being an application (e.g., a program) executed by the processor 505 is only exemplary. The functionality associated with the engine 530 may also be represented as a separate incorporated component of the base station 500 or may be a modular component coupled to the base station 500, e.g., an integrated circuit with or without firmware. For example, the integrated circuit may include input circuitry to receive signals and processing circuitry to process the signals and other information. In addition, in some base stations, the functionality described for the processor 505 is split among a plurality of processors (e.g., a baseband processor, an applications processor, etc.). The exemplary embodiments may be implemented in any of these or other configurations of a base station.

The memory 510 may be a hardware component configured to store data related to operations performed by the base station 500. The I/O device 515 may be a hardware component or ports that enable a user to interact with the base station 500. The transceiver 520 may be a hardware component configured to exchange data with the UE 110. The transceiver 520 may operate on a variety of different frequencies or channels (e.g., set of consecutive frequencies). Therefore, the transceiver 520 may include one or more components (e.g., radios) to enable the data exchange with the various networks and UEs.

### EXAMPLES

In a first example, one or more processors are configured to operate as a sensing function control plane (SF-C), the processors configured to perform operations comprising receiving a sensing session establishment request from an access and mobility management function (AMF) of a core network, wherein the SF-C is located in the core network, selecting a sensing function user plane (SF-U) for a sensing session in response to the request, wherein the SF-U is located outside of the core network and receiving sensing data processing results from the SF-U.

In a second example, the one or more processors of the first example, wherein the SF-U is located in a radio access network (RAN).

In a third example, the one or more processors of the first example, wherein the SF-U is located in a user equipment (UE).

In a fourth example, the one or more processors of the first example, wherein the SF-U is located in an edge network node.

In a fifth example, the one or more processors of the first example, wherein the sensing session establishment request includes a sensing session ID.

In a sixth example, the one or more processors of the first example, wherein the sensing session ID is generated by a user equipment (UE) that initiated a sensing session establishment procedure.

In a seventh example, the one or more processors of the first example, wherein the sensing session ID is generated by a radio access network (RAN) node that initiated a sensing session establishment procedure.

In an eighth example, the one or more processors of the first example, wherein the operations further comprise receiving, prior to selecting the SF-U, subscription information from a unified data management function (UDM).

In a ninth example, the one or more processors of the first example, wherein the operations further comprise receiving, prior to selecting the SF-U, retrieve policy and charging control (PCC) information from a policy and control function (PCF).

In a tenth example, the one or more processors of the first example, wherein the operations further comprise transmitting, to a further network function of the core network, the sensing data processing results.

In an eleventh example, the one or more processors of the first example, wherein the SF-C is configured to perform sensor registration management.

In a twelfth example, the one or more processors of the first example, wherein the SF-C is configured to perform sensor connection management.

In a thirteenth example, the one or more processors of the first example, wherein the SF-C is configured to perform sensor mobility management.

In a fourteenth example, the one or more processors of the first example, wherein the SF-C is configured to perform at least one or sensor access authorization and sensor access authentication.

In a fifteenth example, the one or more processors of the first example, wherein the SF-C is configured to perform sensing session management.

In a sixteenth example, the one or more processors of the fifteenth example, wherein sensing session management comprises at least one of sensing session establishment, sensing session modification, sensing session release or provisioning external parameters for sensing.

In a seventeenth example, the one or more processors of the fifteenth example, wherein sensing session management comprises SF-U selection.

In an eighteenth example, the one or more processors of the fifteenth example, wherein sensing session management comprises terminating interfaces towards policy control functions (PCFs) for sensing.

In a nineteenth example, one or more processors are configured to operate as a sensing function user plane (SF-U), the processors configured to perform operations comprising receiving a sensing session establishment request from a sensing function control plane (SF-C), wherein the SF-C is located in a core network and the SF-U is located outside of the core network, processing sensing data for a sensing session and transmitting sensing data processing results to the SF-C or a radio access network (RAN) node.

In a twentieth example, the one or more processors of the nineteenth example, wherein the SF-U is located in a radio access network (RAN).

In a twenty first example, the one or more processors of the nineteenth example, wherein the SF-U is located in a user equipment (UE).

In a twenty second example, the one or more processors of the nineteenth example, wherein the SF-U is located in an edge network node.

In a twenty third example, the one or more processors of the nineteenth example, wherein the SF-U is configured to perform sensing traffic usage reporting.

In a twenty fourth example, the one or more processors of the nineteenth example, wherein the SF-U is configured to perform sensing policy rule enforcement for the user plane.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method, comprising:
at a sensing function control plane (SF-C):
receiving a sensing session establishment request from an access and mobility management function (AMF) of a core network, wherein the SF-C is located in the core network;
selecting a sensing function user plane (SF-U) for a sensing session in response to the request, wherein the SF-U is located outside of the core network; and
receiving sensing data processing results from the SF-U.

2. The method of claim 1, wherein the SF-U is located in a radio access network (RAN).

3. The method of claim 1, wherein the SF-U is located in a user equipment (UE).

4. The method of claim 1, wherein the SF-U is located in an edge network node.

5. The method of claim 1, wherein the sensing session establishment request includes a sensing session ID.

6. The method of claim 1, wherein the sensing session ID is generated by a user equipment (UE) that initiated a sensing session establishment procedure.

7. The method of claim 1, wherein the sensing session ID is generated by a radio access network (RAN) node that initiated a sensing session establishment procedure.

8. The method of claim 1, further comprising:
receiving, prior to selecting the SF-U, subscription information from a unified data management function (UDM).

9. The method of claim 1, further comprising:
receiving, prior to selecting the SF-U, retrieve policy and charging control (PCC) information from a policy and control function (PCF).

10. The method of claim 1, further comprising:
transmitting, to a further network function of the core network, the sensing data processing results.

11. The method of claim 1, wherein the SF-C is configured to perform sensor registration management.

12. The method of claim 1, wherein the SF-C is configured to perform sensor connection management.

13. The method of claim 1, wherein the SF-C is configured to perform sensor mobility management.

14. The method of claim 1, wherein the SF-C is configured to perform at least one or sensor access authorization and sensor access authentication.

15. The method of claim 1, wherein the SF-C is configured to perform sensing session management.

16-18. (canceled)

19. A method, comprising:
at a sensing function user plane (SF-U):
receiving a sensing session establishment request from a sensing function control plane (SF-C), wherein the SF-C is located in a core network and the SF-U is located outside of the core network;
processing sensing data for a sensing session; and
transmitting sensing data processing results to the SF-C or a radio access network (RAN) node.

20. The method of claim 19, wherein the SF-U is located in a radio access network (RAN).

21. The method of claim 19, wherein the SF-U is located in a user equipment (UE).

22. The method of claim 19, wherein the SF-U is located in an edge network node.

23. The method of claim 19, wherein the SF-U is configured to perform sensing traffic usage reporting or sensing policy rule enforcement for the user plane.

24. (canceled)
